(19) United States
(12) Patent Application Publication
(10) Pub. No.: US 2004/0128838 A1
(43) Pub. Date: Jul. 8, 2004

(54) Filament trimmer head with screw on cap

(76) Inventors: John O. Hurst, Savage, MN (US); Chadwick A. Shaffer, Oakdale, MN (US); John G. DeYoung, Dassel, MN (US)

Correspondence Address: James W. Miller, Esq., Attorney at Law, Foshay Tower, Suite 1005, 821 Marquette Avenue, Minneapolis, MN, 55402, US

(21) Appl. No.: 10/337,204

(22) Filed: Jan. 6, 2003

(51) Int. Cl. B26B 7/00

(52) U.S. Cl. 30/276

(57) ABSTRACT

A trimmer head for a filament trimmer includes a housing and a cap that are separably joined together by a screw thread connection. The housing and the cap enclose and carry a supply of flexible filament the free end of which forms a cutting element for trimming grass when the trimmer head is rotated. The screw thread connection comprises mating external and internal screw threads. One of the screw threads has a rib located on top of one of the turns of the screw thread. This rib cooperates with a leading edge of the other screw thread to prevent the housing and cap from being screwed together too tightly.

### TECHNICAL FIELD

This invention relates to a filament trimmer having a flexible filament that severs grass or other ground growing vegetation when the filament is spun in a cutting plane. More particularly, this invention relates to the trimmer head that carries the flexible filament.

### BACKGROUND OF THE INVENTION

Filament trimmers are well known lawn and garden implements for trimming grass or the like. Such trimmers are handheld implements comprising a lower housing, an upper handle, and an intermediate connecting tube joining the lower housing and upper handle. A trimmer head is rotatably carried on the lower housing. The trimmer head includes a flexible filament extending outwardly therefrom with the filament serving as a cutting element when the filament is swung or rotated in a cutting plane by rotation of the trimmer head.

Many trimmer heads carry a supply of flexible filament wound on a spool. The spool is normally locked relative to the trimmer head to rotate with the trimmer head. However, when the cutting length of the flexible filament becomes shortened due to wear, an indexing system of some type is often used to unlock the spool to permit rotation of the spool relative to the trimmer head to feed out more filament. A well known indexing system is a ground bump indexing system as taught in U.S. Pat. No. 4,524,515 to Oberg, assigned to the assignee of this invention.

The trimmer head is usually formed of two separable parts comprising a housing and a cap that are removably joined together. Together, the housing and the cap define an interior cavity in which the spool is contained. The housing and the cap are often held together by a plurality of flexible tangs that hook or latch into openings. To release the housing and cap from one another, the user has to depress the tangs until such tangs unhook from the openings. As the user keeps the tangs depressed, the housing and cap can be pulled apart from one another and disassembled to permit access to the spool.

The above described use of flexible tangs engaging in openings is an effective way of holding the housing and cap of the trimmer head together. However, in order to ensure that the housing and cap do not inadvertently disengage from one another, the tangs have to engage the openings with a substantial holding force. Thus, it can be difficult for some users to depress the tangs to disengage the housing and cap, particularly when the trimmer head is also clogged with dirt or debris. A trimmer head made of a housing and cap that would always remain engaged during use but which could be more easily disengaged for spool repair or replacement would be desirable.

### SUMMARY OF THE INVENTION

One aspect of this invention relates to a filament trimmer having a rotatable trimmer head that carries a supply of flexible filament therein with a free end of the filament extending radially outwardly from the trimmer head to form a cutting length of filament. The trimmer head includes an indexing system for feeding out additional filament from the trimmer head to replenish the cutting length of the filament when the cutting length is shortened due to wear or usage. The trimmer head includes a cup shaped housing and a cup shaped cap that are releasably joined together, the housing and cap defining an interior cavity in which the supply of flexible filament is carried. The cup shaped housing and cup shaped cap each have peripheral sidewalls that join to one another by a screw thread connection to permit the housing and cap to be connected and disconnected from one another by screwing and unscrewing the housing and cap from one another.

Another aspect of this invention relates to a trimmer head for a filament trimmer. The trimmer head comprises a housing and a cap that are separably joined together by a screw thread connection. A supply of flexible filament is carried within the housing and the cap. The flexible filament has a free end extending radially outwardly from the trimmer head to form a cutting element for trimming grass when the trimmer head is rotated. The screw thread connection comprises mating external and internal screw threads. One of the screw threads has a rib located on top of a turn of the one screw thread. The rib cooperates with a leading edge of the other screw thread to prevent the housing and cap from being screwed together too tightly.

### BRIEF DESCRIPTION OF THE DRAWINGS

This invention will be described more completely in the following Detailed Description, when taken in conjunction with the following drawings, in which like reference numerals refer to like elements throughout.

FIG. 1 is a perspective view of a filament trimmer according to this invention;

FIG. 2 is an exploded perspective view of the trimmer head of the filament trimmer of FIG. 1, particularly illustrating the screw thread connection between the housing and the cap of the trimmer head.

FIG. 3 is another exploded perspective view of the trimmer head of the filament trimmer of FIG. 1, also further illustrating the screw thread connection between the housing and the cap of the trimmer head.

### DETAILED DESCRIPTION

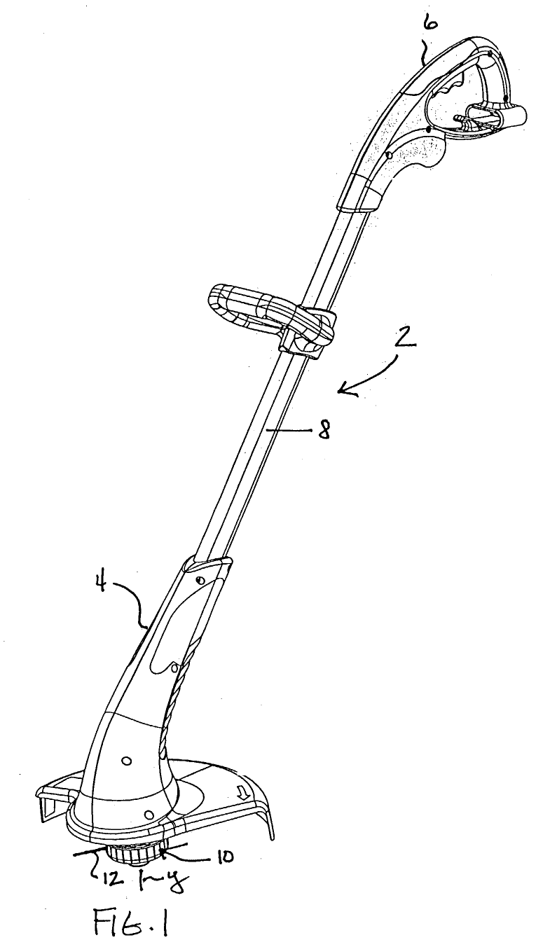

FIG. 1 illustrates a filament trimmer 2 according to this invention. Filament trimmer 2 includes a lower housing 4, an upper handle 6, and an elongated connecting tube 8 joining lower housing 4 and upper handle 6 together. A rotatable trimmer head 10 is carried on lower housing 4. Trimmer head 10 includes a radially outwardly extending flexible filament 12. When trimmer head 10 is rotated relative to lower housing 4 around an axis y, filament 12 is able to cut or trim grass or other ground growing vegetation. An electric drive motor (not shown) is provided in lower housing 4 for rotating trimmer head 10.

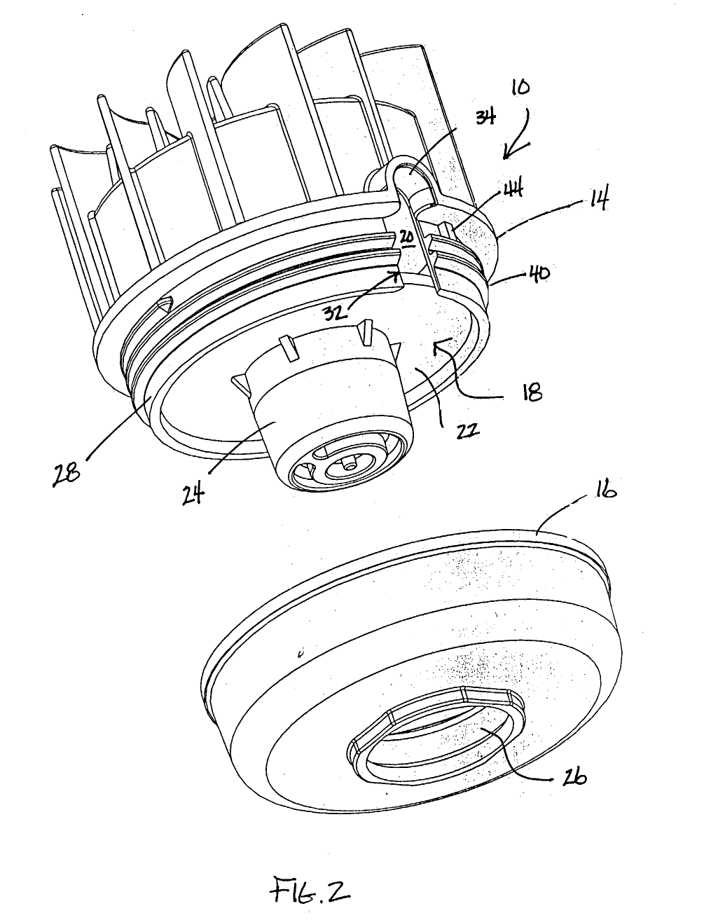

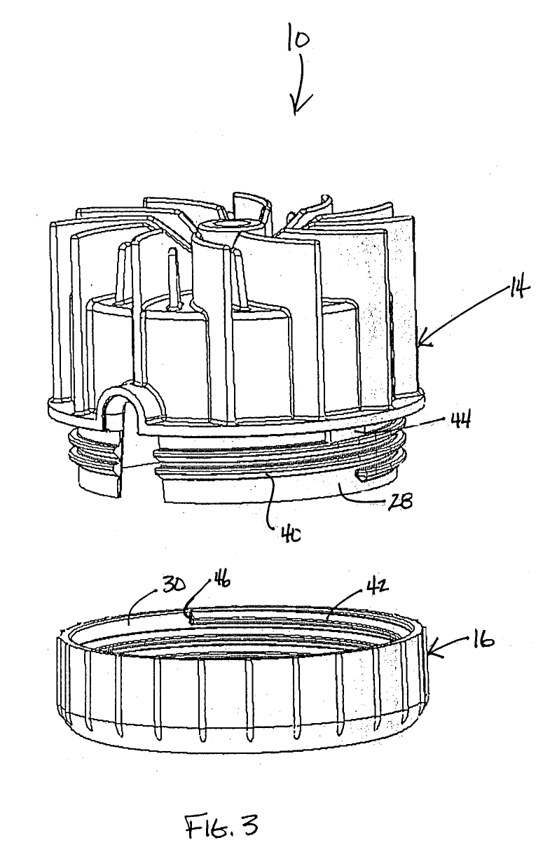

Referring now to FIGS. 2 and 3, trimmer head 10 includes a cup shaped housing 14 and a cup shaped cap 16 that are releasably secured together to allow the two to be connected or disconnected from one another. When housing 14 and cap 16 are connected together, they form an interior cavity in which a spool 18 is carried. Spool 18 includes top and bottom spool flanges 20 and 22 between which a coiled supply of filament 12 is carried. A ground engaging button 24 extends downwardly from bottom spool flange 22. When housing 14 and cap 16 are connected together with spool 18 contained inside the two, ground engaging button 24 extends downwardly through an opening 26 in cap 16 to be able to be bumped against the ground in a line feeding or indexing operation.

When ground engaging button 24 is bumped against the ground, spool 18 is elevated relative to housing 14 to unlock spool 18 from housing 14 to feed out additional filament. Various sets of indexing teeth (not shown) are provided on spool 18 and housing 14 to normally lock spool 18 relative to housing 14. However, these teeth are disengaged during a ground bump indexing operation. When the teeth are disengaged, spool 18 can rotate relative to housing 14 to feed out various increments of additional filament. The teeth and ground engaging button thus form a ground bump indexing system of the type more fully disclosed in U.S. Pat. No. 5,749,148, which patent is hereby incorporated by reference.

Other types of indexing systems could be used. For example, the ground bump indexing system disclosed herein could be replaced with a centrifugal indexing system, as is well known in the art.

Housing 14 and cap 16 each have a perhiperal, cylindrical sidewall 28 and 30, respectively. Sidewall 28 of housing 14 extends downwardly. Sidewall 30 of cap 16 extends upwardly. Sidewall 28 of housing 14 includes a slot 32 through which the free end of filament 12 may be threaded to allow filament 12 to extend radially outwardly from trimmer head 10. When cap 16 is connected to housing 14, sidewall 30 of cap 16 closes off the lower end of slot 32, leaving open only the rounded upper end 34 of slot 32. The rounded upper end 34 of slot 32 forms the exit aperture for filament 12.

Trimmer head 10 as described thus far is known in the art as disclosed in the 148 patent referred to above. This invention relates to a new way of releasably joining housing 14 and cap 16 together.

In this invention, housing 14 and cap 16 are srewed together. Sidewall 28 of housing 14 includes an external screw thread 40 passing over slot 32 such that slot 32 interrupts screw thread 40 over the width of slot 32. Sidewall of cap 16 includes a mating internal screw thread 42 that engages screw thread 40 on housing 14. See FIG. 3. Thus, to connect housing 14 and cap 16, cap 16 is merely screwed onto housing 14 by rotating cap 16 in one direction relative to housing 14. To disconnect housing 14 and cap 16, cap 16 is screwed off housing 14 by rotating cap 16 in the opposite direction. The screw thread connection 40, 42 between housing 14 and cap 16 is in the opposite direction from the direction of rotation of trimmer head 10 so that the operation of trimmer head 10 does not unscrew cap 16 from housing 14.

The use of screw thread connection 40, 42 between housing 14 and cap 16 makes it easy to connect and disconnect the two. All the user has to do is to screw cap 16 on or off housing 14. This is easier to do than depressing flexible tangs and pulling housing 14 and cap 16 apart as is required in known prior art trimmer heads. It is also more intuitive to the user as most users are familiar with screw on and screw off connections.

The rotation of trimmer head 10, and the forces exerted on trimmer head 10 when trimmer head 10 is bumped against the ground, tend to tighten cap 16 on housing 14, i.e. to more firmly screw the two together. It is conceivable that housing 14 and cap could be so firmly screwed together as a result that it would be difficult for a user to unscrew them. To prevent this, a vertical rib 44 is molded on top of the final turn of the screw thread 40 on housing 14. Rib 44 is designed to cooperate with and act as a stop for the leading edge 46 of screw thread 42 on cap 16. When leading edge 46 of screw thread 42 on cap 16 engages rib 44, housing 14 and cap 16 will be firmly connected together but not so tightly connected that they cannot be easily unscrewed. The cooperation of rib 44 with leading edge 46 prevents overtigthening of the screw thread connection 40, 42 between housing 14 and cap 16.

Various modifications of this invention will be apparent to those skilled in the art. Thus, the scope of the invention shall be limited only by the appended claims.

We claim:

1. A filament trimmer, which comprises:
a rotatable trimmer head that carries a supply of flexible filament therein with a free end of the filament extending radially outwardly from the trimmer head to form a cutting length of filament, the trimmer head having an indexing system for feeding out additional filament from the trimmer head to replenish the cutting length of the filament when the cutting length is shortened due to wear or usage, wherein the trimmer head comprises a cup shaped housing and a cup shaped cap that are releasably joined together, the housing and cap defining an interior cavity in which the supply of flexible filament is carried, wherein the cup shaped housing and cup shaped cap each have peripheral sidewalls that join to one another by a screw thread connection to permit the housing and cap to be connected and disconnected from one another by screwing and unscrewing the housing and cap from one another.

2. The trimmer of claim 1, further including means for preventing overtightening of the screw thread connection between the cap and housing.

3. The trimmer of claim 2, wherein the screw thread connection includes an external screw thread on the peripheral sdiewall of the housing and a mating internal screw thread on the peripheral sidewall of the cap.

4. The trimmer of claim 3, wherein the overtightening preventing means comprises a stop formed on one screw thread cooperable with a leading edge of the other screw thread.

5. The trimmer of claim 4, wherein the stop comprises a rib formed on top of a final turn of the one screw thread.

6. The trimmer of claim 3, wherein the peripheral sidewall of the housing includes an elongated slot interrupting the external screw thread, the slot having a rounded upper end forming an exit aperture for the filament.

7. A trimmer head for a filament trimmer, which comprises:
a housing and a cap that are separably joined together by a screw thread connection;
a supply of flexible filament carried within the housing and the cap, wherein the flexible filament has a free end extending radially outwardly from the trimmer head to form a cutting element for trimming grass when the trimmer head is rotated;
wherein the screw thread connection comprises mating external and internal screw threads; and
wherein one of the screw threads has a rib located on top of a turn of the one screw thread, and wherein the rib cooperates with a leading edge of the other screw thread to prevent the housing and cap from being screwed together too tightly.

8. The trimmer head of claim 7, wherein the supply of flexible filament is carried on a spool.

9. The trimmer of claim head of claim 8, wherein the spool is contained in an interior cavity formed by the housing and the cap.

10. The trimmer head of claim 9, further including an indexing system for selectively locking and unlocking the spool relative to the housing to feed out additional increments of the filament.

11. The trimmer of claim 10, wherein the indexing system comprises a ground bump indexing system.
